(19) United States
(12) Patent Application Publication
(10) Pub. No.: US 2014/0120746 A1
(43) Pub. Date: May 1, 2014

(54) ELECTRICAL AND FIBER OPTIC CONNECTOR WITH MAGNETIC ELECTRICAL CONTACTS

(71) Applicants: Rostislav Persion, Nanuet, NY (US); John Tirelli, Wesley Hills, NY (US)

(72) Inventors: Rostislav Persion, Nanuet, NY (US); John Tirelli, Wesley Hills, NY (US)

(21) Appl. No.: 14/062,654

(22) Filed: Oct. 24, 2013

Related U.S. Application Data
(60) Provisional application No. 61/736,660, filed on Dec. 13, 2012.
(60) Provisional application No. 61/718,091, filed on Oct. 24, 2012.

(51) Int. Cl. H01R 13/62

(52) U.S. Cl. CPC H01R 13/6205
USPC 439/39

(57) ABSTRACT

An electrical and optical fiber connecter plug and receptacle relying on magnetic force from a conductive and magnetic material to maintain contact are disclosed. The plug and receptacle can be used as part of a power adapter for connecting an electronic device, such as but not limited to a portable mp3 player or other peripheral device, to a computer. The plug and receptacle include electrical contacts comprised of conductive magnetic material, which are arranged in such a way as to make it impossible to improperly attach the connectors due to magnetic polarity and the design of the male and female connector. The plug and receptacle will also include an optical fiber to transmit data.

### CROSS-REFERENCE TO RELATED APPLICATION

The present application claims priority to U.S. patent application 61/736,660, filed Dec. 13, 2012, and U.S. Patent Application 61/718,091, filed Oct. 24, 2012, each of which is hereby expressly incorporated by reference in its entireties.

### FIELD OF THE INVENTION

The present invention relates to a system and apparatus for establishing an electrical and data connection between at least two devices. The present invention is directed to a magnetically engaged connecter plug unit and receiving units which rely on magnetic force maintain proper alignment and connection between the units.

### BACKGROUND OF THE INVENTION

Mobile computing devices have become very popular with consumers. Consumers have chosen these devices for portability as well as for additional functions such as listening to music, watching video and surfing the internet. These devices generally use rechargeable batteries and require constant recharging. Charging is done by a charging cable that is often used for data transmission as well.

Data transmission speeds are increasing, but are inherently limited. Current data transmission speeds are approaching their theoretical limit based on current copper wire signal transmission technology. In contrast optical fibers transmit data at rates greatly exceeding those achievable by copper wiring. However, optical conduits, such as fiber optic cables, are incapable of transmitting power.

There exist in the art some apparatuses that teach the ability to provide electrical power using magnetic connections in a single connector. However, devices such as the one described in U.S. Pat. No. 7,517,222 to Rohrbach, hereby incorporated by reference, are unsuited for higher data transmission speeds. Likewise, the prior art describes fiber optic connections between computing devices. For example, U.S. Pat. No. 6,105,096 to Martinelli, herein incorporated by reference, discloses the use of fiber optic cables in order to network computing devices. However, the devices of the prior art are large unsightly and cumbersome to use. Furthermore, the described fiber optic elements are insufficiently shielded to allow for multi channel transmissions. Lastly, the prior art connectors and interfaces are difficult for a consumer to use since the fiber optic connector must be aligned manually in order to transmit properly.

What is needed is a connector system that provides power and data transfer capabilities, one that is easily connected and does not requiring the user to properly configure or orient the system prior to use. It is also desirable to have a connector system that can be disconnected easily without breaking or resetting the connections. Furthermore, what is needed is a connector system that easily disengages when the cable or connector is pulled away if the cable accidently disengaged. Additionally, what is needed is a device that allows for faster communication between mobile devices.

### SUMMARY OF THE INVENTION

In accordance with broad aspects of the present invention, the system and apparatus disclosed herein provides a system and device for power and data transfer connectors that supply both power and data to between devices or between devices and power sources using a specialized connector.

In more particular aspects, the present system and apparatus provide for power and data transmission connectors that transmit data and power to mobile computing or other types of devices using magnetic coupling mechanisms. Furthermore, the present invention is configured to provide adaptor systems for connecting fiber-optic and power cables to mobile computing or other types of devices. For example, the device described herein is directed to a magnetic connector type that is configured to transmit data and power through surface contact. This connector type is configured to connect to a second connector type that is configured such that the magnetic polarities of the first and second connector are aligned to allow magnetic coupling. Similarly, the magnetic polarity and orientation of the connectors are configured such that an improper connection between the two connectors is indicated and prevented by a strong repulsive magnetic force.

In a particular arrangement, each connector is equipped with a plurality of magnetic elements configured to exert magnetic force such that the connectors are moved and secured into a coupled arrangement where opposite polarity elements are attracted to one another. Through the resulting magnetic seal, data and electrical energy are transferred from one connector to another. In another example, a pin connector type is magnetically coupled to a socket connector type so as to receive and physically secure the connector from lateral movement.

### BRIEF DESCRIPTION OF THE DRAWINGS

The foregoing and other features of the present invention will be more readily apparent from the following detailed description and drawings of an exemplary arrangement of the elements of the device described in which:

FIG. 1 illustrates a perspective view of a power and data transfer system according to an embodiment of the present invention;

FIG. 2 illustrates an alternative power and data transfer system according to an embodiment of the device described in FIG. 1;

FIG. 3 illustrates a cutaway view of elements of a power and data transfer system according to an embodiment of the present invention;

FIG. 4 illustrates a still further arrangement of the power and data transfer system according to an embodiment of the present invention;

FIG. 5 illustrates a still further arrangement of the power and data transfer system according to an embodiment of the present invention;

FIG. 6 illustrates a still further arrangement of the power and data transfer system according to an embodiment of the present invention.

### DISCUSSION OF CERTAIN ARRANGEMENTS OF THE ILLUSTRATED DEVICE

By way of overview and introduction, the present system and apparatus provides specialized data and power connectors designed to secure power and data transmissions. Specifically, the system and apparatus of the present invention are configured to use magnetic attraction and repulsion principals to ensure proper orientation of data transmission elements and power conduits, allowing for a simple and effective solution to the deficiencies found in the prior art. In one arrangement, the present invention provides for an electrical and optical fiber connecter plug and receiver system which utilizes magnetic force in order to maintain constant contact between the elements of the system.

In a different arrangement, the plug and receptacle can be used as part of a power adapter for connecting electronic devices, such as portable mp3 players and other peripheral devices, to a computer. The plug and receptacle described in the present system and apparatus include electrical contacts having conductive magnetic elements. These elements are arranged to make it difficult to improperly attach the connectors.

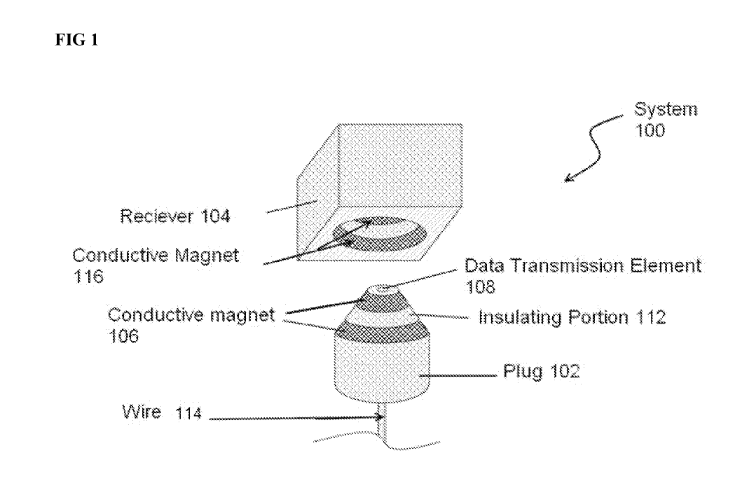

As illustrated in FIG. 1, the present system provides for an electrical and data connecter plug and receptacle where secure coupling between the plug and receptacle is accomplished via magnetic attractive forces. In one arrangement, the illustrated system is provided as part of a power adapter for connecting an electronic device.

FIG. 1 describes a power and data connector plug 102 configured for insertion into a receptacle 104. The data and power plug 102 is equipped with a plurality of magnetic elements 106, which upon the insertion of the plug 102 into the receptacle 104; magnetically couple the plug 102 to the receptacle 104. By matching the magnetic elements 106 of the data and power plug to reciprocal magnetic elements 116 located within the receptacle 104 a secure connection is made between the two parts of the connector system. In one arrangement of the elements, the magnetic elements 106 have alternating polarities, such that same polarity elements are not arranged in close proximity to one another.

In a further arrangement, the magnetic elements 106 function as electrical contacts. In this arrangement, each magnetic element (106, 116) is formed of a material having electrical and magnetic properties, such as a ferromagnetic material. In this arrangement, electrical power is transmitted to the magnetic elements 106 from a wire or conduit 114 to the magnetic elements 116 located on the surface of the electrical and data receiver 104. The power and data plug 102 is also equipped with a data transmission element 108. The data transmission element 108 is configured to transmit data from the power and data plug 102 to the electrical and data receptacle 104. In one arrangement of elements, the data transmission element 108 is an optical transmission device, such as a fiber optic data transmitter. In this arrangement, the secured coupling of the power and data plug 102 to the electrical and data receiver 104 enables the optical transmission of data between the electrical and data receptacle 104 and the power and data plug 102. In various embodiments of the present invention, the data is provided using fiber-optic connections that include one, two, four, or other numbers of fiber-optic cables. In a specific embodiment of the present invention, one multi-channel fiber-optic cable is used, in which at least one channel of each is used for data transmission and data reception.

In this illustrated arrangement of the present system and apparatus, the one fiber-optic cable is arranged such that the connection between the power and data plug 102 and electrical and data receptacle 104 is only allowable in the proper orientation, such as along all the data and electrical plug's 102 axis of symmetry. That is, the power and data plug 102 is attached to the electrical and data receptacle 104 and capable of being rotated without binding or breaking fiber optic connection. In this arrangement, the data connection is made using the one fiber-optic cable transmitting bi-directionally. In a further arrangement, the interior surface of the electrical and data receiver 104 and the power and data plug 102 are both mirrored such that any stray optical signals are reflected back to the receiver.

In an alternate arrangement, the data transmission element is an electrical data connection. In a further arrangement the data transmission element is a combined optical and electrical data transmission device. In those arrangements of elements wherein the data transmission elements incorporate electrical data transmission elements, the plug 102 and receptacle 104 are equipped with the necessary electrical grounding and insulation materials.

The described plug and receiver can employ two, four, or more magnetic contacts for power transmission. For example, the illustrated device provides two magnetic contact areas, one for a power supply voltage and one for a ground connection. In various embodiments of the present device, the connector plug and receptacle employ one or more magnets that hold the connector in place, align the optical fiber and conduct the electricity needed to power a peripheral device.

The receptacle 104 is equipped with reciprocal magnetic elements 116 such that upon insertion of the power and data plug 102, magnetic forces securely retain the plug 102 within the receptacle 104 without the necessity of springs, clamps or other coupling fasteners. By inserting the connector plug 102 into the receptacle 104, a secure data and power connection is established between the data plug and the receptacle 104. In the described arrangement, the plug 102 and receptacle 104 are provided with opposite orienting magnetic elements so that the repulsive forces generated by magnets of the same polarity are sufficient to prevent the incorrect insertion of the plug.

The magnetic forces employed to secure the plug and the receptacle is also configured to enable the power and/or data connections. For example, the described system allows for the arrangement of electrical contacts within the receptacle 104. In a given arrangement, the current is continuously available. The flow is only halted if it is connected to a conductive material that could cause a short circuit (for example through a threshold current).

In the depicted arrangement, the plug and receptacle are formed out of standard non-conductive materials. For example, in FIG. 1, it is envisioned that the connector plug 102 and receptacle 104 are formed of plastic, coated metal, carbon-fiber or similar materials that allow for the ease of manufacture and durability required of connectors typically found in the art.

Additionally, the power and data plug 102 is configured to communicate bi-directionally with other device interfaces through the use of an adaptor (not shown) such as adaptors configured to convert the data connection to a standard fiber-optic transmitter, or Local Area Networking (LAN) interface, Universal Serial Bus (USB) interface, Digital Visual Interface (DVI) interface, DisplayPort interface, IEEE 802.11 a, b, g, n, or other types of connection interfaces.

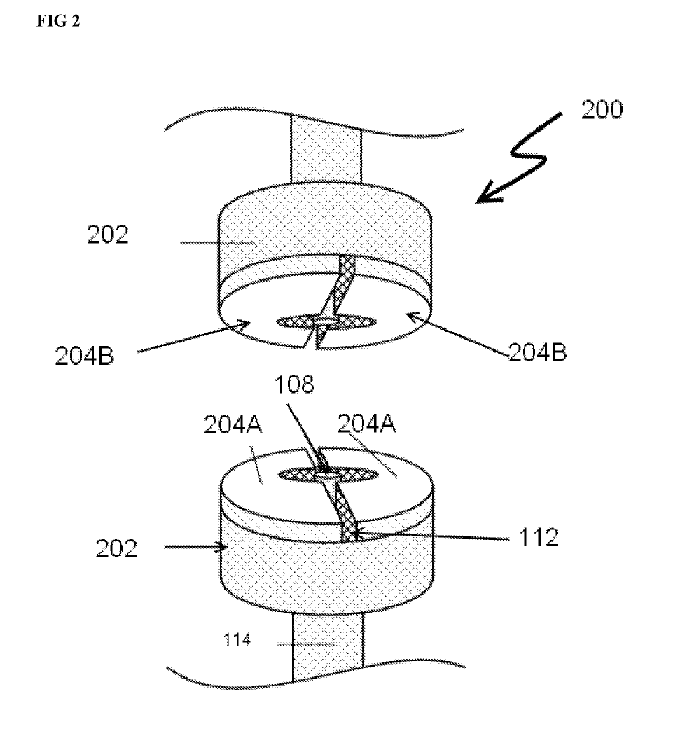

In an alternative arrangement, as seen in FIG. 2, the connector system 200 employs two identical data and electrical plugs 202. In this arrangement, the plugs 202 are configured to connect to one another in the proper orientation due to magnetic attraction. The illustrated embodiment provides for one or more magnets (204A, B) to couple the connectors 102 to one another. As seen in the illustrated arrangement, the one or more magnets 204A, 204B are attracted to their polar opposite magnet region. In the illustrated arrangement, the connectors 202 are fitted with a single orientation magnetic element 204A, 204B. The magnetic elements are located on the exterior surface of the connectors 202 and are configured such that the opposing polarities are aligned. Furthermore, the magnetic elements are electrically conductive so as to transmit electrical power between the connectors 202.

In a given configuration, the polarities of the magnetic elements are aligned such that a user is prevented from improperly coupling the voltage and ground portions of the electrical connection. In this arrangement a positive voltage (for example 5VDC) and a ground state exists between the ferromagnetic connectors (204A, B) such that by connecting positive end of one to the negative ends of another connector produces a coupled electrical connection. In this arrangement, it is envisioned that each connector 202 that is associated with a separate device is so configured such that the polarities are matched so as to avoid shorting or faulting. For example, in the present illustration, one of the connectors 202 is configured to be integral to a device, such as a tablet computer, or an external periphery device. The reciprocal connector is a cable connector that is equipped to connect the device to a power source or to another device having a similar integral connector. In this way, the proper alignment of magnetic elements and electrical polarities is maintained through the cable 108. In the described arrangement, the user is prevented from forming a connection having an improper polarity.

Each connector 202 is also configured to transmit electrical power or a combined power and data signal over through the magnetic elements 204A, B. In the illustrated arrangement, the contact surface of the connector 202 is formed of a conductive material separated by insulators 212 that prevent the electrical connection from shorting across the surface. In one arrangement the contact surface includes a layer of copper, gold, or any similar substance or alloy thereof having necessary conductive properties that can by coated or applied to a material having magnetic properties.

As illustrated, the connector 202 is equipped with a data transfer element 206 located at the center of the connector 202. In the illustrated arrangement, the data transfer element 206 is a fiber optic optical transmission element. In this arrangement, upon magnetic coupling of two connectors 202, the fiber optic elements are aligned such that data can be transferred between the optical elements of the fiber optic device. By way of non-limiting example, the fiber optic elements in the given arrangement are standard fiber optic terminal elements wherein the optical cable is terminated with optically transparent material so as to prevent access to the interior of the optical fiber. Those skilled in the art will appreciate the various potential arrangements of the fiber optic elements and materials necessary to effectuate the device herein described.

In a further embodiment of the device described in FIG. 2, the area between the electrical contact and the data transfer element 106 is mirrored or otherwise made reflective to the optical signals generated by the data transfer element 106. In this arrangement, the signals generated are reflected so as to minimize loss of data through an incomplete coupling of the complementary data transfer elements. Additionally, the device illustrated is equipped with a conduit or cable 108 which provides data and power to a device or power source. In the illustrated example the conduit 108 is equipped with at least two terminal ends.

In the illustrated configuration, the at least one terminal end is equipped with the connector 202 as provided in FIG. 2. In an additional arrangement, the other end of the conduit is equipped with an adaptor that allows connection or coupling to any standard interface device such as a USB connector, Firewire, or wireless transmitter. Additionally, in a further configuration, either end of the conduit is equipped with a connector 102 as described in FIG. 1. In this arrangement, the connector is configured to couple with an adaptor device which adapts the present invention for communication with a USB or other standard interface equipped device.

The power and data adapter 202 may thus translate or convert data using these one or more protocols into optical data and provide that data to mobile computing devices. The power and data adapter 202 may also translate or convert optical data from the computing or other type of device to data consistent with one or more of these protocols to be provided to one or more other devices. The data may be provided by the power and data adapter 202 using one or more fiber-optic cables.

It is envisioned that a variety of peripheral devices are configured to communicate with each other through the illustrated power and data system. For example, two or more USB devices may communicate with each other via a corresponding number of USB-equipped connectors on the power and data adapter. In this arrangement is provided that at one end of a power and data cable. The power and data adapter may also include circuitry for translating among these wired and wireless protocols and one or more protocols suitable for fiber-optic communications. The power and data adapter may communicate with the mobile computing or other type of device over a single cable that includes conductors for the DC power and one or more fiber-optic cables.

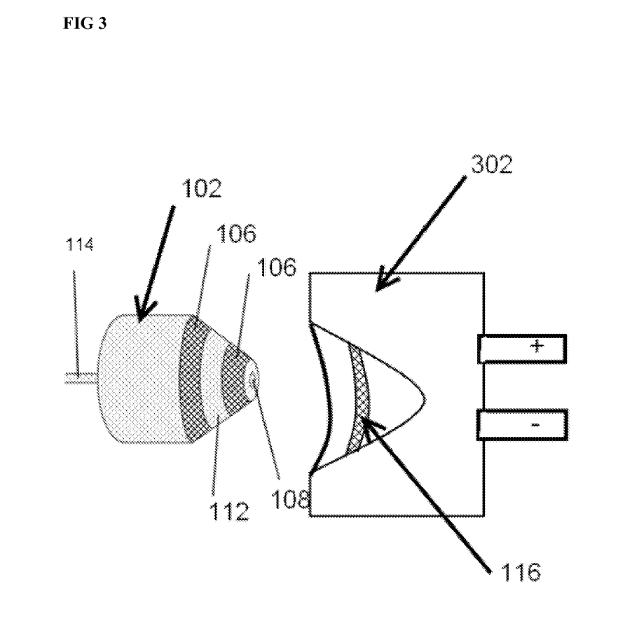

As seen in FIG. 3, in an alternative embodiment, the present device also includes a wall or electrical outlet adaptor 302. The adapter is configured to provide power and data to device. For example, the adaptor is configured to transmit and receive data signals through household wiring by voltage or frequency modulation techniques. The invention so described may receive power and data from a wall, car, computer or other type outlet. The power and data adapter may directly connect to the outlet, or it may connect to the outlet via a power cord or cable. A specific embodiment of the present invention plugs directly into a wall outlet. In this case, the power and data adapter may also include circuitry for converting AC power to DC power suitable for being provided to the mobile computing or other type of device.

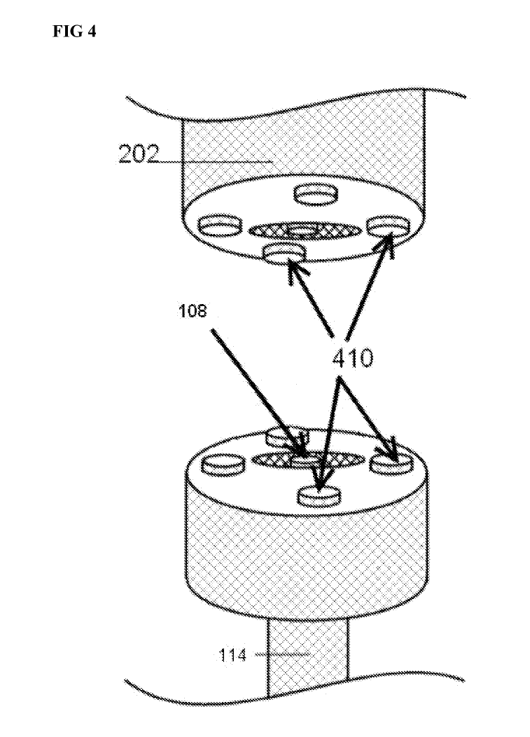

As seen in FIG. 4, the present invention provides a further exemplary arrangement of elements. FIG. 4 illustrates the use of a connector system that provides both power and data through the use of spring supported pistons 410. In this arrangement the spring supported pistons 410, are arranged around the periphery of the connector 202. In this arrangement the spring connectors are coupled to corresponding switches located within the connectors. When the magnetic attraction of the connectors compresses the pistons, the springs are compressed. This compression activates an electrical connection that permits power to be directed from one connector to another.

In another exemplary embodiment the device described prevents power from being applied at an electrical and data receiver 104 until the power and data plug 102 is inserted. In one embodiment of the present invention, the electrical and data receiver 104 provides a small amount of current between power and ground terminals of the power and data plug 102. A resulting voltage is then detected by the receiver. If the voltage is in a predetermined range, power is applied to the electrical and data receiver 104 through the electrically conductive magnetic elements. For example, in a particular embodiment, the switch mechanism is a current-threshold deactivation switch that will disengages power if the current is above a maximum threshold.

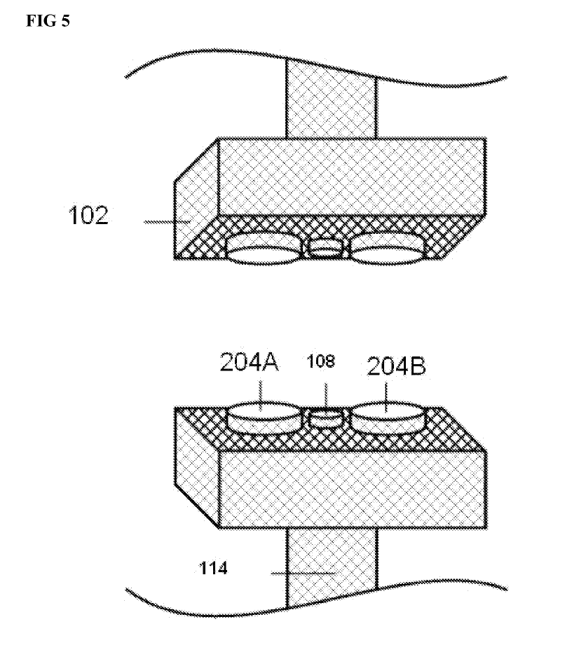

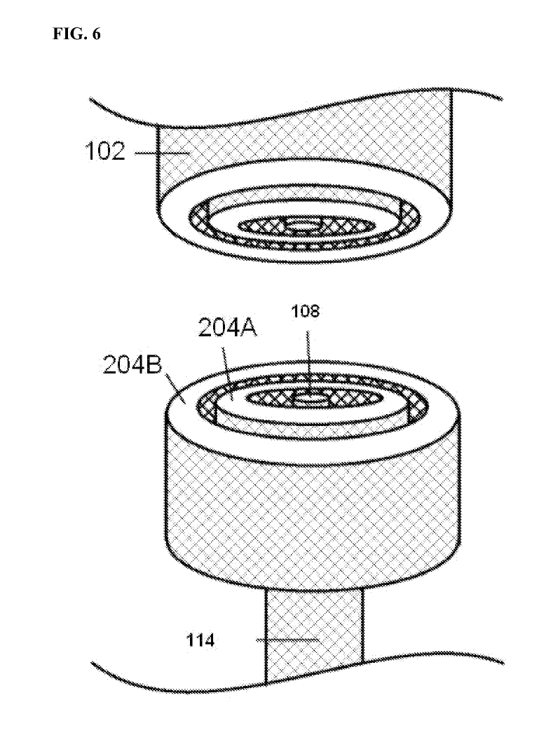

FIG. 5-6 provides alternatives arrangements of the elements herein described with respect to FIG. 1-2. It should be understood that additional modifications of each of the FIGs illustrated are envisioned.

In another embodiment of the present system, identification or other signal is provided by the connector. If a proper response is received, power is applied to the insert's electrically conductive magnets. Further embodiments may require that such an identification signal be periodically provided. When the identification is not received for a period of time, power is removed from the connector.

It should be understood that various combinations, alternatives and modifications of the present invention could be devised by those skilled in the art. The present invention is intended to embrace all such alternatives, modifications and variances that fall within the scope of the appended claims.

While the invention has been particularly shown and described with reference to a preferred embodiment thereof, it will be understood by those skilled in the art that various changes in form and details may be made therein without departing from the spirit and scope of the invention.

We claim:

1. A connector system for the transmission of data, the system comprising:
A first connector segment having an connection head, the connection head equipped with a first data transmission port, a portion of the connection head equipped with at least one magnetic surface element having a magnetic polarity;
A second connector segment having a connection head receiver, the connection head receiver equipped with a second data transmission port configured to couple to the first transmission port and the connection head receiver is equipped with at least one magnetic surface element of the opposite polarity as the magnetic element of the connection head.

2. The connector system of claim 1, wherein the connection head is conical in shape and configured to be inserted into the connection head receiver, the connection head receiver configured with a corresponding receiving portion.

3. The connector system of claim 2, wherein the data transmission port is configured to transmit data as pulsed light energy optical wavelengths.

4. The connector system of claim 2, data transmission port is configured to transmit data as pulsed light energy optical wavelengths and electrical signals.

5. The connector system of claim 1 wherein the surface of the connector head and the surface of the connection receiver are equipped with electrically conductive elements.

6. The connector system of claim 5 wherein electrically conductive elements are co-extensive with the magnetic elements.

7. The connector system of claim 6 wherein the connection head is further configured with a sensor activated switch that is activated upon sensing the contact.

8. The connector system of claim 7 wherein the sensor activated switch includes a current thresh-hold sensor and a deactivation switch.

9. The connector system of claim 7, wherein the sensor activated switch controls the flow of electrical current to the electrically conductive elements.

10. The connector system of claim 9, wherein the sensor deactivation switch is activated by current exceeding the preconfigured threshold.
